(19) United States
(12) Patent Application Publication
(10) Pub. No.: US 2006/0088374 A1
(43) Pub. Date: Apr. 27, 2006

(54) Welding joint of fuel tank

(75) Inventors: Takahiro Nishiyama, Kasugai-shi (JP); Kensuke Sasai, Komaki-shi (JP); Kazutaka Katayama, Kasugai-shi (JP); Hiroaki Ito, Kasugai-shi (JP); Nobuaki Niki, Inuyama-shi (JP); Junichiro Suzuki, Kasugai-shi (JP)

Correspondence Address: DARBY & DARBY P.C., P. O. BOX 5257, NEW YORK, NY, 10150-5257, US

(73) Assignee: TOKAI RUBBER INDUSTRIES, LTD., Komaki-Shi (JP)

(21) Appl. No.: 11/255,247

(22) Filed: Oct. 21, 2005

(30) Foreign Application Priority Data
Oct. 22, 2004 (JP) 2004-308957
Jun. 30, 2005 (JP) 2005-192914

(51) Int. Cl. F16B 11/00

(52) U.S. Cl. 403/271; 403/270

(57) ABSTRACT

A welding joint has a cylindrical portion being a connection portion, and an annular fusion-welded portion disposed at a base end part of the cylindrical portion, the fusion-welded portion being configured to be thermal fusion welded to a resin-made fuel tank. The cylindrical portion is constructed by employing a resinous alloy material in which a modified high-density polyethylene obtained by introducing a functional group of high affinity to a hydroxyl group of ethylene-vinylalcohol copolymer is alloyed with the ethylene-vinylalcohol copolymer, and at least the fusion-welded portion comprises an inner layer employing the resinous alloy material and an outer layer employing at least one of the high-density polyethylene and the modified high-density polyethylene and externally covering the inner layer.

### BACKGROUND OF THE INVENTION

1. Field of the Invention

This invention relates to a resin-made joint for connecting a piping tube or a connector to a resin-made fuel tank, and more particularly to a resin-made welding joint which is fusion-welded to a fuel tank so as to construct a connection portion.

2. Description of the Related Art

A fuel tank which is mounted on an automobile is integrally provided with a joint that serves to connect a tube, a connector or the like for introducing fuel poured from a filler opening, into the fuel tank.

Here, in case of, for example, the tube which introduces the fuel from the filler opening into the fuel tank, a rubber made tube (rubber hose) has hitherto been employed. In recent years, however, the permeability of the fuel to the exterior through the hose has been severely regulated from the viewpoint of the preservation of the environment. Therefore, a rubber/resin compound tube in which the rubber hose further includes a barrier layer of resin, a rubber tube which is made of a fluorine rubber having a fuel permeability resistance, or a resin tube which is made of only a resin has come to be adopted as the piping tube.

Heretofore, a connection structure as shown in FIGS. 4A and 4B by way of example has been adopted as the connection structure of such a tube for the fuel tank.

Referring to FIG. 4A, numeral 200 designates a fuel tank made of a resin, and numeral 202 a welding joint similarly made of a resin. The welding joint 202 is integrated to the fuel tank 200 by thermal fusion welding.

The welding joint 202 includes a cylindrical portion 204 being a tube fitting portion, and it is provided with an annular flange portion 206 which protrudes from the outer peripheral surface of the cylindrical portion 204.

Numeral 208 designates a resin tube for introducing fuel poured from a filler opening into the fuel tank 200. As shown in FIG. 4B, the resin tube 208 is provided with a bellows portion 210 in order to afford a flexibility.

Referring to FIGS. 4B and 5; numeral 212 designates a connector (quick connector), through which the resin tube 208 is connected to the welding joint 202.

The connector 212 is constituted by a connector main body 214 made of a resin, and a retainer 216 similarly made of a resin.

The connector main body 214 includes a nipple portion 218 on one side in the axial direction thereof, and also includes on the other side a socket-like retainer holding portion 230 which holds the retainer 216 that is elastically inserted thereinto.

The nipple portion 218 is a portion onto which the resin tube 208 is press-fitted in an externally fit state so as to fix this resin tube. This nipple portion 218 is formed at its outer peripheral surface with a coming-off preventive portion which has a plurality of annular protrusions 232 at axial intervals, and whose section is in a saw-tooth shape. Besides, a plurality of O-rings (seal rings) 234 are held on the inner peripheral side of the nipple portion 218.

On the other hand, the socket-like retainer holding portion 230 is provided with a recess 236 in a circular arc shape, and a partial ring-shaped portion 238 in a corresponding circular arc shape.

The retainer 216 is elastically deformable in its radial direction as a whole. This retainer 216 includes a circular arc-shaped groove 240 into which the partial ring-shaped portion 238 in the retainer holding portion 230 is elastically fitted, a tapered guide surface 242 which serves to guide the axial insertion of the flange portion 206 on the side of the welding joint 202 and to elastically enlarge the diameter of the whole retainer 216, and a circular arc-shaped engagement recess 244 into which the flange portion 206 is engaged.

With this connection structure, the end part of the resin tube 208 is forcibly press-fitted onto the nipple portion 218 of the connector main body 214, thereby to be fixed.

In that case, the end part of the resin tube 208 is deformed with its diameter enlarged as shown in FIG. 4B, owing to the press fit onto the nipple portion 218, thereby to tighten the nipple portion 218 in the radial direction of the connector main body 214 by a strong tightening force.

Owing to the tightening force and the biting action of the annular protrusions 232 provided in the nipple portion 218, the end part of the resin tube 208 is fixed to the connector main body 214.

The retainer 216 is attached to and held by the connector main body 214, and in that state, the connector 212 is externally fitted on the cylindrical portion 204 of the welding joint 202.

On this occasion, the retainer 216 held by the connector main body 214 is elastically deformed with its diameter enlarged, by the flange portion 206. When the flange portion 206 has reached the engagement recess 244, the retainer 216 is elastically deformed again with its diameter reduced, whereby the flange portion 206 and the engagement recess 244 become an engaged state.

Simultaneously, that part of the cylindrical portion 204 which lies on the distal end side thereof with respect to the flange portion 206 becomes fitted in the O-rings 234 on the inner peripheral side of the connector main body 214, whereby hermetic sealing is established between the cylindrical portion 204 and the connector main body 214.

Meanwhile, unlike the above connection structure, it has been conceived to directly fit and connect the resin tube 208 onto and with the cylindrical portion 204 of the welding joint 202 without the intervention of the connector 212.

Such a welding joint for connecting the connector (quick connector) or for directly connecting the fuel piping tube is integrally joined to the fuel tank by the thermal fusion welding as stated above. In the case of constructing the connection portion of the tube by employing such a welding joint, a problem to be stated below occurs.

Heretofore, an HDPE (high-density polyethylene) resin has been employed as the outer layer material of the fuel tank. Accordingly, the welding joint to be integrated with the fuel tank is required to be fusion-weldable to this fuel tank.

It is considered that, for the purpose of the fusion welding, the whole welding joint including the cylindrical portion is constructed of the HDPE resin of the identical material. However, although the HDPE resin has an excellent fusion-weldability to the fuel tank, it exhibits an insufficient fuel-permeability resistance to incur the problem that fuel permeates out of the welding joint.

With the object of solving the problem of the fuel permeability resistance, JP-A-2002-254938 discloses that a welding joint is constructed by stacking in its radial direction, an outer layer which has a fusion-weldability with the fuel tank, and an inner layer which is made of a resin material having a fuel permeability resistance (barrier ability).

FIG. 6 shows an example of the welding joint.

Referring to FIG. 6, numeral 246 designates a resin-made fuel tank, which is constructed by stacking an outer layer 246-1 and an inner layer 246-3 made of the HDPE resin, and a barrier layer 246-2 made of an EVOH (ethylene-vinylalcohol copolymer) resin of excellent fuel-permeability resistance.

Numeral 248 designates a resin-made welding joint which is fusion-welded and integrated to the fuel tank 246. The welding joint 248 includes a cylindrical portion 252 serving as a connection portion (fitting portion) for a tube 258, and a fusion-welded portion 250 being the base end part of this welding joint, and it has the fusion-welded portion 250 fixed to the fuel tank 246 by thermal fusion welding.

The cylindrical portion 252 includes an outer layer 254 and an inner layer 256 which are made of different resin materials. More specifically, the outer layer 254 is made of the same resin material as that of the fusion-welded portion 250, and the inner layer 256 is made of a barrier material, such as PA (polyamide) resin, which is superior in fuel permeability resistance to the resin material of the outer layer 254.

Incidentally, numeral 260 designates a hose band which clamps the tube 258 in a fitted state.

In the welding joint of this structure, when the outer layer 254 and the fusion-welded portion 250 in the cylindrical portion 252 are made of the HDPE resin of the identical material which is highly fusion-weldable to the fuel tank 246, this HDPE resin exhibits an insufficient fuel-permeability resistance (therefore, the inner layer 256 of the cylindrical portion 252 is made of the barrier material in the welding joint 248 shown in FIG. 6). Accordingly, even if a fuel permeability resistance can be ensured for the cylindrical portion 252, the fusion-welded portion 250 made of the HDPE resin is, so to speak, in a “bare state”, and the problem is inherent that fuel within the fuel tank 246 permeates out through the fusion-welded portion 250.

Meanwhile, JP-A-2002-241546 discloses to alloy an EVOH copolymer and a polyolephin resin, and to construct a fuel treatment member which has the resin phase separation structure of a sea-island structure with a continuous phase (sea) being EVOH and a separated phase (islands) being polyolephin, by the use of such a resinous alloy material.

It is considered that, in the welding joint 248, the fusion-welded portion 250 is made of the resinous alloy material disclosed in JP-A-2002-241546.

Thus, it can be expected to endow the fusion-welded portion 250 with the excellent fusion-weldability of the HDPE and the high fuel-permeability resistance based on the EVOH.

The EVOH, however, is not always sufficient in waterproofing. When exposed to moisture for a long time, the EVOH absorbs the moisture to incur the problem of lowering in the fuel permeability resistance and also in strength. The fusion-welded portion 250 in the welding joint 248 is a part which might be exposed to moisture. When the whole fusion-welded portion 250 is made of such a resinous alloy material, the fuel permeability resistance and the strength are apprehended to lower with the passage of time.

### SUMMARY OF THE INVENTION

The present invention has the above circumstances as its background, and has been made with the object of providing that welding joint of a fuel tank which can be maintained for a long term without the bad influences of moisture on a favorable fusion-weldability and fuel-permeability resistance in a fusion-welded portion for the fuel tank, and in which even a cylindrical poriton exhibits a favorable fuel-permeability resistance.

According to a first aspect of the invention, there is provided a welding joint that includes a cylindrical portion being a connection portion for a piping tube or connector, and an annular fusion-welded portion disposed at a base end part of the cylindrical portion. The fusion-welded portion is configured to be thermal fusion-welded to a peripheral edge part of an opening of a resin-made fuel tank, thereby to be integrated with the fuel tank. The cylindrical portion is constructed by employing a resinous alloy material in which a modified HDPE obtained by introducing a functional group of high affinity to a hydroxyl group of EVOH is alloyed with the EVOH singly or together with HDPE, and at least the fusion-welded portion is constructed of a stacked structure which comprises an inner layer employing the resinous alloy material, and an outer layer employing the HDPE and/or the modified HDPE and externally covering the inner layer.

According to a second aspect of the invention, the outer layer extends to a position which reaches a distal end of a tube that is fitted onto the cylindrical portion in an externally fit state, and a part of the cylindrical portion which extends from the fusion-welded portion to the position reaching the distal end of the tube comprises the inner layer and the outer layer.

According to a third aspect of the invention, the welding joint further includes a waterproof seal ring disposed on a part of the outer layer of the cylindrical portion which is fitted into the tube, the waterproof seal ring sealing an interspace between the outer peripheral surface of the cylindrical portion and an inner peripheral surface of the tube.

As described above, the cylindrical portion of a welding joint is constructed by employing a resinous alloy material in which a modified HDPE (high-density polyethylene) obtained by introducing a functional group of high affinity to a hydroxyl group of EVOH (ethylene-vinylalcohol copolymer) is alloyed with the EVOH singly or together with HDPE free from such a functional group. At least the fusion-welded portion of the welding joint is constructed of a stacked structure which includes an inner layer employing the alloy material, and an outer layer externally covering the inner layer and employing the HDPE resin of high fusion-weldability to a fuel tank and/or the modified HDPE resin.

As stated above, the EVOH has heretofore been known as a material of excellent gas-barrier ability. The resinous alloy material in which the modified HDPE is alloyed to such an EVOH has an excellent fusion-weldability to the fuel tank, owing to the HDPE contained in this alloy material, and it also has a high fuel-permeability resistance (barrier ability) based on the EVOH. In accordance with the invention, accordingly, the cylindrical portion of the welding joint can be endowed with the excellent fuel-permeability resistance, and the fusion-welded portion can be endowed with the excellent fuel-permeability resistance and the favorable fusion-weldability.

In accordance with the invention, accordingly, the permeation of fuel gas from the fusion-welded portion is favorably preventable unlike in the welding joint shown in FIG. 6.

The invention features the point that the inner layer of the fusion-welded portion as is made of the resinous alloy material is externally covered with the outer layer which employs the HDPE resin and/or the modified HDPE resin (hereinbelow, these are simply termed “HDPE resin”).

As stated before, the EVOH is not always sufficient in waterproofing, and when exposed to moisture for a long time, it absorbs the moisture to lower in the fuel permeability resistance and also in strength.

Especially, that part of the fuel tank to which the fusion-welded portion is fusion-welded is a part which might be exposed to moisture.

In this regard, in the invention, the inner layer employing the resinous alloy material is externally covered with the outer layer which employs the HDPE resin having a high tolerance to moisture. In accordance with the invention, therefore, the inner layer in, at least, the fusion-welded portion can be cut off and protected from the external moisture by the outer layer employing the HDPE resin, whereby the excellent fuel-permeability resistance and fusion-welding strength of the fusion-welded portion can be stably maintained over a long term.

According to the second aspect of the invention, in a case where a tube is directly fitted onto the cylindrical portion by press fit, the outer layer in the fusion-welded portion is formed so as to extend on a cylindrical portion side to a position which reaches the distal end of the tube, and a part of the cylindrical portion which extends to the position reaching the distal end of the tube forms the stacked structure which includes the inner layer employing the resinous alloy material, and the outer layer externally covering the inner layer and employing the HDPE resin. In accordance with the invention, even at the exposed part of the cylindrical portion as is not externally covered with the tube, that is, at the part thereof as extends from the fusion-welded portion to the position reaching the distal end of the tube, the inner layer lying on an inner side and employing the resinous alloy material can be cut off and protected from external moisture by the outer layer lying on an outer side and made of the HDPE resin. Even in the cylindrical portion, accordingly, the favorable fuel-permeability resistance can be stably maintained over a long term.

According to the third aspect of the invention, a waterproof seal ring is mounted on the outer layer of the cylindrical portion at a position corresponding to the distal end part of the tube, so as to seal the interspace between the outer peripheral surface of the cylindrical portion and the inner peripheral surface of the tube by the waterproof seal ring. Thus, moisture can be prevented by the waterproof seal ring from intruding between the inner peripheral surface of the tube and the outer peripheral surface of the cylindrical portion at the distal end side part thereof. Therefore, even in a case where the distal end side part of the cylindrical portion as is externally covered with the tube is made of the resinous alloy material singly, the fuel permeability resistance of the distal end side part of the cylindrical portion is not apprehended to lower due to the moisture, and the excellent fuel-permeability resistance can be stably maintained over a long term even at the part.

In accordance with the third aspect of the invention, an effect to be stated below is also attained.

The HDPE resin is not sufficient in the point of a sag resistance, and when this HDPE resin has undergone a strong tightening force from the tube, it is liable to plastic deformation and permanent strain, and the coming-off preventive force or sealability of the tube is apprehended to lower with the passage of time. In accordance with the third aspect of the invention, however, that distal end part of the cylindrical portion which undergoes the tightening force ascribable to the tube is made of the resinous alloy material whose sag resistance is high. Therefore, the problem can be favorably solved that the distal end side part of the cylindrical portion as undergoes the tightening force ascribable to the tube is elastically deformed to give rise to the permanent strain and to lower the coming-off preventive force and sealability of the tube with the passage of time.

### BRIEF DESCRIPTION OF THE DRAWINGS

FIG. 1 is a view showing a welding joint according to an embodiment of the present invention;

FIGS. 2A and 2B are perspective views showing essential portions in FIG. 1;

FIG. 3A is a model diagram showing an example of the existent aspect of EVOH of a resinous alloy material for use in the embodiment, and FIG. 3B shows a comparative example;

FIGS. 4A and 4B are explanatory views showing a prior-art connection scheme of a resin tube for a fuel tank;

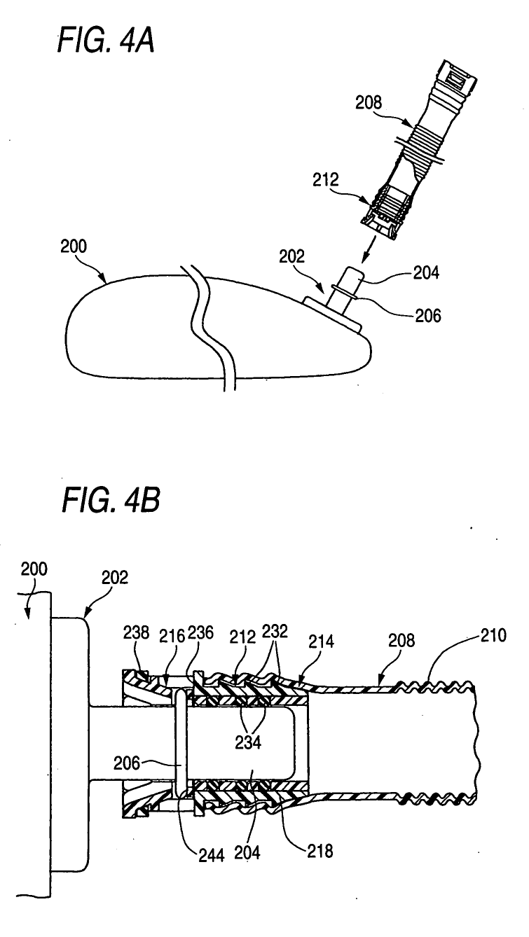

FIG. 5 is a view showing the individual exploded members of a connection structure in FIG. 4; and

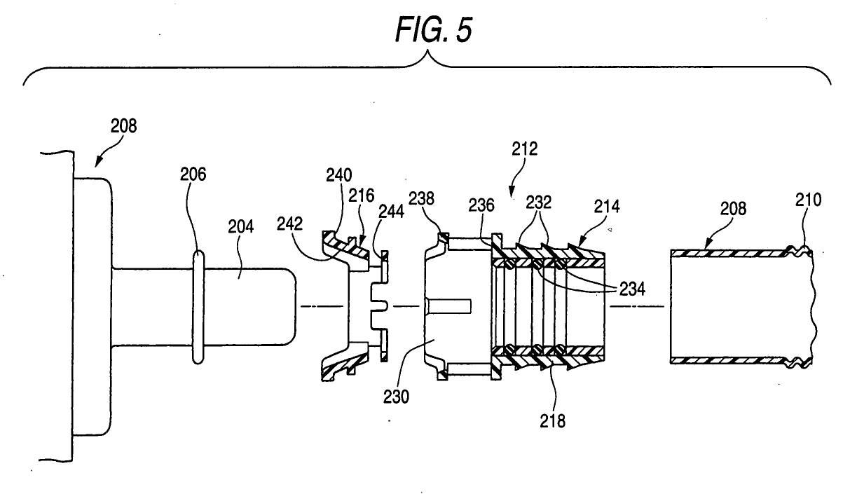

FIG. 6 is a view showing a constructional conventional example of a welding joint.

### DETAILED DESCRIPTION OF THE PREFFERED EMBODIMENT

Now, an embodiment of the present invention will be described in detail with reference to the drawings.

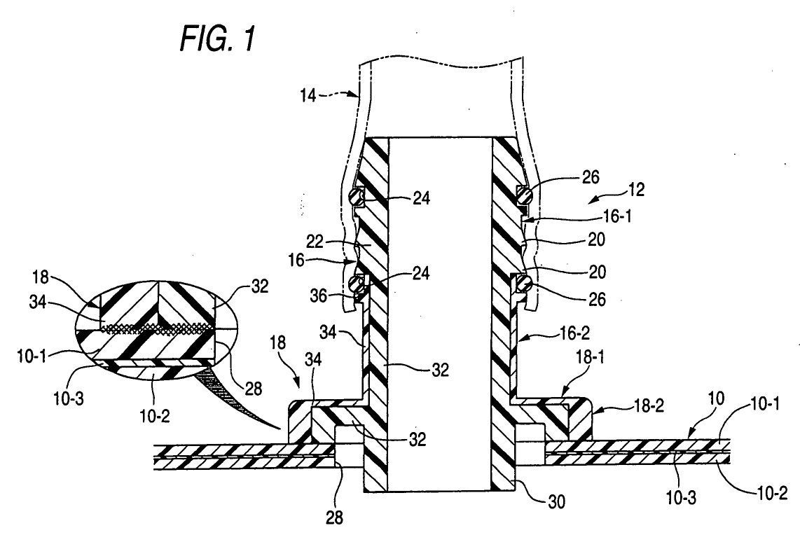

Referring to FIG. 1, numeral 10 designates a resin-made fuel tank. Here, the fuel tank 10 includes an outer layer 10-1 and an inner layer 10-2 which are made of an HDPE resin, and it has a sectional structure in which a thin barrier layer 10-3 is sandwiched in between the outer and inner layers.

In this case, also the barrier layer 10-3 forms an inner layer relative to the outer layer 10-1.

Numeral 12 designates a resin-made welding joint, which includes a cylindrical portion 16 serving as a connection portion for a piping tube (hereinbelow, simply called as “tube”) 14, and a fusion-welded portion 18 lying at the base end part of this welding joint.

The tube 14 is fitted onto the cylindrical portion 16 in an externally fit state by press fit, and it is connected to the fuel tank 10 through such a welding joint 12.

The cylindrical portion 16 includes a fitting portion 16-1 on the distal end side of this cylindrical portion as is inserted into the tube 14, and a base portion 16-2 on the side of the fuel tank 10. The outer peripheral surface of the fitting portion 16-1 on the distal end side is provided with a coming-off preventive portion 22 which has a plurality of annular protrusions 20 at axial intervals. The sectional shape of the coming-off preventive portion 22 is a saw-tooth shape.

Besides, the outer peripheral surface of the cylindrical portion 16 is formed with annular grooves 24 at an intermediate position in the axial direction of this cylindrical portion and a position near the distal end thereof, and O-rings 26 being waterproof seal rings are accommodated and held in the annular grooves 24.

The O-rings 26 function to establish hermetic sealing between the outer peripheral surface of the cylindrical portion 16 and the inner peripheral surface of the tube 14. Here, at least one (lower one) of the O-rings 26 is disposed on an outer layer 34, which will be described later, of the cylindrical portion 16. Thus, even in a case where the distal end side part of the cylindrical portion 16 is made of resinous alloy material singly, the fuel permeability resistance of the distal end side part of the cylindrical portion is not apprehended to lower due to the moisture, and the excellent fuel-permeability resistance can be stably maintained over a long term even at the part.

The coming-off preventive portion 22 functions to prevent the tube 14 from coming off, in such a way that each annular protrusion 20 whose distal end defines an acute angle bites into the inner surface of the tube 14.

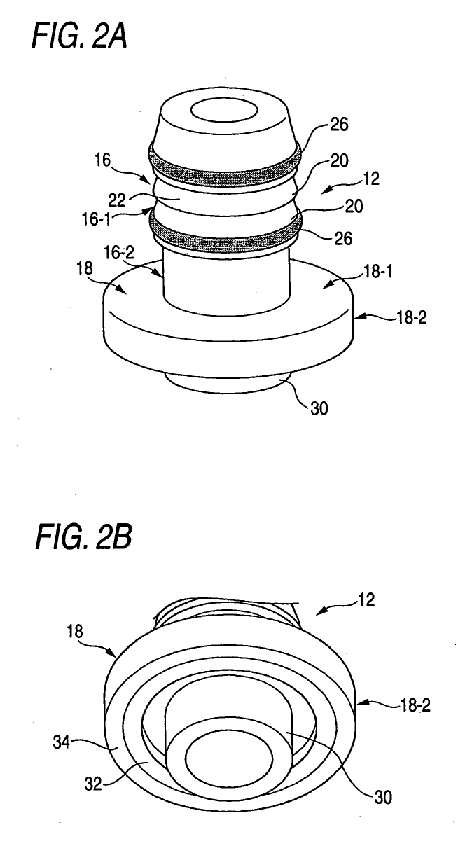

As also shown in FIGS. 2A and 2B (FIGS. 2A and 2B show the state of the welding joint 12 before fusion welding), the fusion-welded portion 18 includes a large-diameter disc-shaped flange portion 18-1 which extends radially outward from the cylindrical portion 16, and a fall portion 18-2 which falls from the outer peripheral end part of the flange portion 18-1 toward the side of the fuel tank 10 and which defines an annulus around an opening 28 of the fuel tank 10. At the end face of the fall portion 18-2, the fusion-welded portion 18 is integrated to the peripheral edge part of the opening 28 of the fuel tank 10, concretely, to the outer layer 10-2 by thermal fusion welding.

The welding joint 12 is also provided with an annular projection portion 30 which projects oppositely to the cylindrical portion 16, namely, toward the interior of the opening 28.

The projection portion 30 is employed for connection with the resin-made casing of a valve or the like arranged within the fuel tank 10.

The fusion-welded portion 18 forms a stacked structure as a whole, consisting of an inner layer 32 and an outer layer 34, and the end faces of the respective layers are both fusion-welded to the fuel tank 10 by the thermal fusion welding.

Here, the inner layer 32 and the outer layer 34 are integrally molded by two color injection molding.

Besides, the outer layer 34 in the fusion-welded portion 18 extends to a position which reaches the inner side of the distal end part of the tube 14. The base portion 16-2 in the cylindrical portion 16 forms a stacked structure which consists of an inner layer 32 made of the same material as that of the inner layer 32 in the fusion-welded portion 18, and an outer layer 34 made of the same material as that of the outer layer 34 in the fusion-welded portion 18.

In this embodiment, the whole fitting portion 16-1 of the distal end side in the cylindrical portion 16, the inner layer 32 in the base portion 16-2, and the projection portion 30 as well as the inner layer 32 in the fusion-welded portion 18 are constructed of a resinous alloy material. The resinous alloy material is produced in such a way that modified HDPE (high-density polyethylene), into which a functional group having a high affinity to a hydroxyl group of EVOH (ethylene-vinylalcohol copolymer) is introduced, is alloyed with the EVOH singly or together with ordinary HDPE.

Besides, the outer layer 34 in the fusion-welded portion 18 and the outer layer 34 of the base portion 16-2 in the cylindrical portion 16 are constructed of an HDPE resin whose fusion-weldability is high to the fuel tank 10, more specifically to the outer layer 10-1 thereof (incidentally, the above modified HDPE resin, or a mixed material consisting of the ordinary HDPE resin and the modified HDPE resin may well be employed for the outer layers 34).

In the embodiment as described above, the cylindrical portion 16 of the welding joint 12 can be endowed with an excellent fuel-permeability resistance. Besides, the fusion-welded portion 18 can be endowed with both the excellent fuel-permeability resistance and a favorable fusion-weldability to the fuel tank 10.

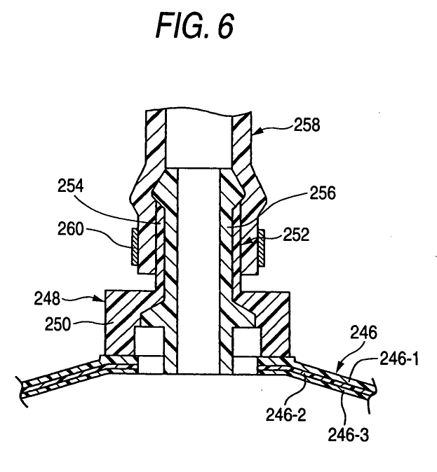

Unlike the known welding joint shown in FIG. 6, accordingly the welding joint 12 can favorably prevent fuel gas from permeating from the fusion-welded portion 18.

Further, in this embodiment, the inner layer 32 which is made of the resinous alloy material having a low tolerance to moisture is externally covered with the outer layer 34 which is made of the HDPE resin having a high tolerance to the moisture, that is, the inner layer 32 is cut off and protected from the external moisture by the outer layer 34. Therefore, the excellent fuel-permeability resistance and fusion-welding strength in the fusion-welded portion 18 can be stably maintained over a long term.

Besides, in this embodiment, the outer layer 34 in the fusion-welded portion 18 is formed so as to extend onto the side of the cylindrical portion 16, and the base portion 16-2 of the cylindrical portion 16 is constructed as the stacked structure which consists of the inner layer 32 made of the resinous alloy material, and the outer layer 34 of the HDPE resin externally covering this inner layer. Even at the part of the cylindrical portion 16 exposed to the exterior, therefore, the favorable fuel-permeability resistance can be stably maintained over a long term.

On the other hand, the fitting portion 16-1 on the distal end side in the cylindrical portion 16 is made only of the resinous alloy material, but the intrusion of moisture into the interspace between the fitting portion 16-1 and the tube 14 is checked by the O-rings, 26. Accordingly, the fitting portion 16-1 is not apprehended to lower in the fuel-permeability resistance due to the moisture, and the excellent fuel-permeability resistance can be stably maintained over a long term even in this portion 16-1.

Besides, the HDPE resin is not sufficient in the point of a sag resistance, and when this HDPE resin has undergone a strong tightening force from the tube 14, it is liable to plastic deformation and permanent strain, and the coming-off preventive force or sealability of the tube 14 is apprehended to lower with the passage of time. In this embodiment, however, that fitting portion 16-1 of the cylindrical portion 16 onto which the tube 14 is fitted and which undergoes the tightening force ascribable to the tube 14 is made of the resinous alloy material whose sag resistance is high. In spite of the tightening force ascribable to the tube 14, therefore, the coming-off preventive force and sealability of the tube 14 can be held over a long term.

In this embodiment, unlike the ordinary HDPE, the modified HDPE is employed as the material to be alloyed with the EVOH, and this is for the following reason.

The ordinary HDPE is scanty of affinity to the EVOH. Accordingly, when the ordinary HDPE is intended to be alloyed with the EVOH, the EVOH and HDPE become large bulks in a partial localized state on account of the nonaffinity between them.

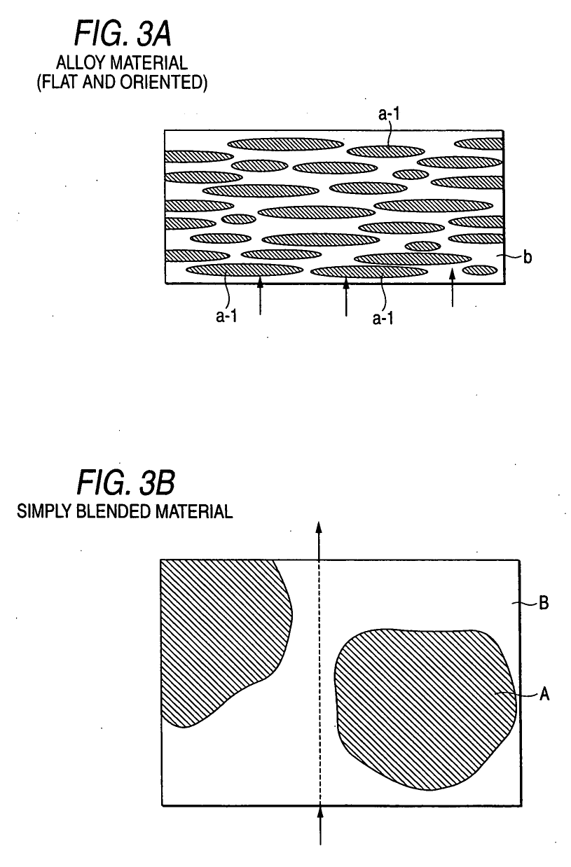

By way of example, as shown in FIG. 3B in model-like fashion, the EVOH becomes large bulks A in a state where they are unevenly distributed within the matrix B of the HDPE.

In this case, although the EVOH itself is excellent in the fuel permeability resistance, the large bulks A thereof are separate from one another and are localized within the matrix B of the HDPE, so that the fuel gas easily passes among the bulks A of the EVOH and leaks out.

Such a situation is ascribable to the fact that the EVOH and the HDPE are the combination of phase-insoluble materials, so even when both the resins are physically mixed, they give rise to phase separation and form interfaces of low affinity.

As a result, the mixed material (blended material) becomes a state where the large bulks A of the EVOH are contained as if they were foreign matters. In the state, the mixed material becomes low in strength (crumbly), and exfoliation is prone to occur at the interfaces between both the resins.

In contrast, in this embodiment, the modified HDPE resin in which the functional group having chemical reactivities (chiefly, hydrogen bonding and covalent bonding) to the hydroxyl group of the EVOH is introduced is employed as the material to be alloyed with the EVOH. Therefore, the EVOH and the HDPE are evenly mixed and dispersed, and both the resins become a state where they melt together.

Thus, the favorable fusion-weldability (fusion-weldability in the fusion-welded portion 18) and fuel-permeability resistance (barrier ability) are both realized.

As stated above, the-EVOH and the HDPE are evenly mixed and dispersed to form a homogeneous phase in which they melt together. The reason therefor is that the HDPE has come to exhibit the high affinity to the EVOH, owing to the modification based on the introduction of the functional group.

Moreover, the resinous alloy material in which the EVOH and the modified HDPE are alloyed heightens in the shock resistance of the material simultaneously with the strength thereof, because both the resins are evenly mixed and dispersed to form the homogeneous phase.

Here, examples of the modifying group, namely, the functional group which is introduced into the HDPE, are a carboxyl group, a carbonate-anhydride residual group, an epoxy group, an acrylate group, a methacrylate group, a vinyl acetate group, and an amino group.

Besides, the fusion-welding strength can be heightened by raising the proportion of the HDPE, and the fuel permeability resistance can be enhanced by raising the proportion of the EVOH. Either of the fusion-welding strength and the fuel permeability resistance can be coped with by adjusting the proportion in this manner. As the proportion, the ratio of the EVOH/the modified HDPE can be set at 80/20-15/85 in terms of weight.

Besides, since any phase-dissolving agent is not contained in the compounding, the resinous alloy material is excellent in the fuel permeability resistance. If necessary, however, a phase-dissolving agent, an inorganic filler or the like may well be compounded in the resinous alloy material. On this occasion, when the phase-dissolving agent is excessively added, the crystallinity of the base material is lowered to increase fuel permeability (to lower barrier ability), so that the phase-dissolving agent is added within a range in which a required barrier performance is ensured.

Further, apart from alloying the modified HDPE singly with the EVOH, both the ordinary HDPE and the modified HDPE may well be alloyed with the EVOH.

In this embodiment, the resinous alloy material can be brought into the sea-island structure in which either of the EVOH and the modified HDPE forms the sea, while the other forms islands. Especially in case of the sea-island structure in which the modified HDPE forms the sea, while the EVOH forms the islands, the aspect of existence of the EVOH may well be islands a-1 which have a flat shape and are oriented in an identical direction as shown in FIG. 3A. In this case, the fuel permeability resistance can be enhanced more effectively.

By the way, in this embodiment, the base portion 16-2 in the cylindrical portion 16 is constructed of the stacked structure consisting of the inner layer 32 and the outer layer 34, together with the fusion-welded portion 18, but the invention is not limited as herein described. For example, only the fusion-welded portion 18 can be constructed of the stacked structure consisting of the inner layer 32 and the outer layer 34.

Even in such a case, there is attained the advantage that the lowering of the fuel permeability resistance or the strength attributed to the absorption of moisture by an inner layer 36 in the fusion-welded portion 18 is favorably preventable by an outer layer 38 which externally clothes the inner layer 36.

Although the embodiment of the invention has been detailed above, it is exemplary, and the invention can be constructed in various altered aspects within a scope not departing from the purport thereof.

What is claimed is:

1. A welding joint comprising:
a cylindrical portion being a connection portion; and
an annular fusion-welded portion disposed at a base end part of the cylindrical portion, the fusion-welded portion being configured to be thermal fusion welded to a resin-made fuel tank;
wherein the cylindrical portion is constructed by employing a resinous alloy material in which a modified high-density polyethylene obtained by introducing a functional group of high affinity to a hydroxyl group of ethylene-vinylalcohol copolymer is alloyed with the ethylene-vinylalcohol copolymer, and at least the fusion-welded portion comprises an inner layer employing the resinous alloy material and an outer layer employing at least one of the high-density polyethylene and the modified high-density polyethylene and externally covering the inner layer.

2. A welding joint-comprising:
a cylindrical portion being a connection portion; and
an annular fusion-welded portion disposed at a base end part of the cylindrical portion, the fusion-welded portion being configured to be thermal fusion welded to a resin-made fuel tank;
wherein the cylindrical portion is constructed by employing a resinous alloy material in which a modified high-density polyethylene obtained by introducing a functional group of high affinity to a hydroxyl group of ethylene-vinylalcohol copolymer is alloyed with the ethylene-vinylalcohol copolymer together with high-density polyethylene, and at least the fusion-welded portion comprises an inner layer employing the resinous alloy material and an outer layer employing at least one of the high-density polyethylene and the modified high-density polyethylene and externally covering the inner layer.

3. The welding joint according to claim 1, wherein the outer layer extends to a position which reaches a distal end of a tube that is fitted onto the cylindrical portion in an externally fit state, and a part of the cylindrical portion which extends from the fusion-welded portion to the position reaching the distal end of the tube comprises the inner layer and the outer layer.

4. The welding joint according to claim 2, wherein the outer layer extends to a position which reaches a distal end of a tube that is fitted onto the cylindrical portion in an externally fit state, and a part of the cylindrical portion which extends from the fusion-welded portion to the position reaching the distal end of the tube comprises the inner layer and the outer layer.

5. The welding joint according to claim 3, further comprising a waterproof seal ring disposed on the outer layer of the cylindrical portion which is fitted into the tube, the waterproof seal ring sealing an interspace between the outer peripheral surface of the cylindrical portion and an inner peripheral surface of the tube.

6. The welding joint according to claim 4, further comprising a waterproof seal ring disposed on the outer layer of the cylindrical portion which is fitted into the tube, the waterproof seal ring sealing an interspace between the outer peripheral surface of the cylindrical portion and an inner peripheral surface of the tube.
